(19) United States
(12) Patent Application Publication
(10) Pub. No.: US 2010/0173086 A1
(43) Pub. Date: Jul. 8, 2010

(54) Modification of Paper Coating Rheology

(76) Inventors: Howard Roger Dungworth, Brighouse (GB); David Petty, Bradford (GB); Olli Juhani Jokinen, Lohja (FI)

Correspondence Address: BASF Performance Products LLC;Patent Department, 540 White Plains Road, P.O. Box 2005, Tarrytown, NY, 10591, US

(21) Appl. No.: 12/496,981

(22) Filed: Jul. 2, 2009

Related U.S. Application Data
(63) Continuation-in-part of application No. 10/545,754, filed on Aug. 15, 2005, now abandoned.

(30) Foreign Application Priority Data
Feb. 26, 2003 (GB) 0304354.4

(51) Int. Cl. B05D 3/02; C08L 31/02

(52) U.S. Cl. 427/391; 524/556

(57) ABSTRACT

Thickener compositions for addition to paper coating compositions in order to obtain low high shear viscosity and good water retention are disclosed. The thickener compositions comprise an associative polymer with an associative monomer content below 10% by weight, based on the weight of the polymer, a weight average molecular weight below one million and an acid monomer content of at least 10% by weight, based on the weight of the polymer.

This is a continuation in part of U.S. application Ser. No. 10/545,754, pending, which is a national stage of PCT/EP 04/001426, filed Feb. 16, 2004, the contents of which applications are incorporated by reference.

This invention relates to paper coating and more particularly the modification of paper coating rheology.

Various types of polymeric thickeners are well documented in the prior art. Often these are in the form of aqueous emulsions which are either alkali soluble or alkali swellable.

WO-A-00/34361 describes a comb polymer comprising a backbone of hydrophilic units and dihalogeno compounds and a moiety contain pendent hydrophobe, being particularly suited as a thickener for latex paints. The hydrophobic group is attached to the backbone of the preformed polymer.

WO-A-02/12360 describes an aqueous dispersion of copolymeric microparticles, useful as an associative thickener in coating compositions such as paints. The thickeners exemplified include at least 10% by weight associative monomer.

U.S. Pat. No. 5,478,602 describes coating a substrate by applying an aqueous coating composition containing an alkali swellable complex hydrophobe associative thickener. Since the polymer is alkali swellable it must be so substantially cross-linked that the polymer is not soluble.

It is well known that associative thickeners bring about low high shear viscosity at small dosages. They can thus give an economic advantage over other types of synthetic thickeners. However an equally well known problem with associative thickeners is that they provide poor water retention. So the economic advantage of associative thickeners is normally only obtained in conditions where water retention is not important.

Water retention of coating colours has a profound influence on the runnability of the paper coating process. The coating colour loses a large proportion of the water that it contains as soon as it comes into contact with the surface of the paper owing to capillary action, the extent of which depends on the absorbency of the substrate. The pressure in the nip and under the blade also promotes dewatering. The release of water from the coating colour can have the following consequences:

The solids content of the wet coating increases which modifies the rheology of the coating before it comes into contact with the blade. In the worst case the coating can form a thick, immobile “filter cake” which can cause streaking and might even cause the web to break.

The water taken up by the paper causes a reduction in its internal bonding strength which causes it to tear more easily under tension.

The solids content of the coating colour re-circulated from the coater head can increase by 5% and more over a period of a few hours because the concentration of water soluble polymer in the coating colour is also much lower if too much water is released. This phenomenon is often observed at the precoating stage.

It becomes more difficult to apply an even coat as the solids content of the coating colour increases. The blade pressure often has to be increased in order to maintain a constant coat weight.

In the manufacture of paper there is a tendency to seek ever higher coating speeds and this requires lower high shear viscosity. Although low high shear viscosity can be provided by associative thickeners the low water retention of those thickeners can result in water from the coating permeating the paper thus weakening the paper. This in turn can place an unacceptable limit on the coating speed. In addition rapid release of water from the coating may prevent the desired smoothing of the coating.

When the coating composition does not exhibit low high shear viscosity the rod pressure of the coating apparatus can increase significantly. On the other hand when the coating composition results in poor water retention on the rod pressure tends to be unstable. In both instances in this can result in damage to the coated paper and/or poor runnability of the coater.

In order to improve the water retention other products need to be added together with the associative thickeners and the economic advantage of those thickeners is no longer obtained. As far as we are aware no proposals have been made for improving water retention when using associative thickeners in paper coating without the addition of an additional water retention aid so as to obtain the economic benefits of using associative thickeners for paper coating.

The present invention has been made in order to address this problem.

According to the invention there is provided an associative thickener for modifying the rheology of paper coatings, where the thickener comprises an associative polymer, where the associative monomer content of the polymer is below 10% by weight, based on the weight of the polymer, the weight average molecular weight of the polymer is below about 1 million, and the acid monomer content of the polymer is at least 10% by weight, based on the weight of the polymer.

The terms “associative monomer content” and “acid monomer content” mean the associative monomer units and acid monomer units content.

Molecular weights for the present polymers are reported in weight average molecular weights.

We have discovered that the adjustment of the three parameters of an associative polymer, associative monomer content, molecular weight and acid monomer content within the limits defined above provides an associative thickener composition which results in both low high shear viscosity and good water retention without the necessity for the addition of a water retention aid.

It must be understood that while the three above mentioned parameters are seen as essential for obtaining the desired combination of low high shear viscosity and good water retention the dosage of the thickener will also have an effect on the performance of the thickener. For example lowering of the molecular weight may require an increase in the dosage if the desired viscosity is to be obtained. In addition, lowering the acid monomer content can lower the efficiency of the thickener so that an increase in dosage may be needed. Once these consequences have been appreciated the appropriate adjustment becomes a matter for a limited amount of experimentation in order to obtain the desired result.

Associative thickeners for obtaining low high shear viscosity are well known. They comprise hydrophilic, water soluble associative polymers with hydrophobic terminal groups or side chains. The hydrophobic terminal groups may be aliphatic or aromatic hydrocarbons and they are water insoluble. They can be joined to the hydrophilic polymer backbone by means of a hydrophilic spacer so that they remain flexible. Their structure is similar to that of surfactants. Interaction between the hydrophobic groups or side chains is what is considered to provide for very high viscosity at low shear. There are various types of associative polymers but those which are generally useful for the purpose of the present invention are formed from ethylenically unsaturated monomers such as (meth) acrylic acid, (meth)acrylates, maleic acid or anhydride, maleates, itaconic acid, itaconates, allyl ethers and vinyl esters. (Meth) acrylic acid means both acrylic acid and methacrylic acid. Ideally the choice of monomers is such that the polymer is insoluble in water and at neutral pHs, but dissolves under alkali conditions, for instance pH 8 to 10 or higher. The polymers are typically made by aqueous emulsion polymerisation of the monomers to form an aqueous emulsion of a polymer. Polymers of particular interest in connection with the present invention are the hydrophobic alkali-soluble emulsions in which the hydrophilic polymer backbone comprises an alkali-soluble polyacrylate derived from monomers such as alkyl acrylates for example ethyl acrylate, acrylic acid or methacrylic acid. The hydrophibic side chains are attached to the polymer backbone by, for example, a polyoxyethylene oxide spacer. Normally the hydrophobic side chains are provided by including ethylenically unsaturated monomers that contain the hydrophobic side chains. Typically the hydrophobic side chains are C₈-C₃₀ alkyl groups. Thus the hydrophobic side chain moiety can be bonded to ethylenically unsaturated components such as acrylamido, acrylate or allyloxy etc. The thickening effect can be adjusted by altering the ratios of the monomers. All this is well known. Examples of associative thickeners used as paint thickeners, printing pastes and the like are disclosed in U.S. Pat. Nos. 4,677,152 and 5,210,324. Other associative thickeners are described in detail in European Patent Specification 0 013 836 A1 and U.S. Pat. No. 4,384,096. These can be used in the present invention subject to their being modified in accordance with the definition of the invention as set out above. The U.S. patents and applications listed herein are incorporated by reference.

We have found that associative polymers must have the special combination of an acid monomer content of at least 10% by weight and an associative monomer content of below 10% by weight and weight average molecular weight below 1 million. Molecular weights of below 700,000 have been found to be particularly suitable for use in the present invention. An especially preferred molecular weight range is 70,000 to 150,000, and most preferably 70,000 to below 100,000 (weight average molecular weights).

The polymers may be made by the inclusion of branching or cross-linking agents and/or chain transfer agents. However, it is preferred that the amounts of branching or cross-linking agents are used in amounts such that the polymer is substantially soluble in at least in alkali. Thus the polymer may be substantially linear, branched or slightly cross-linked. Nevertheless, the polymers desirably should not be so cross-linked that it is insoluble. The amount of cross linking agent is generally below 2000 ppm (by weight) and preferably below 1000 ppm. Typically the amount of cross-linking agent will be below 500 ppm, for instance in the range of 1 or 2 ppm up to for instance 100 ppm, preferably 5 ppm up to 20 or 30 ppm. The cross-linking agent can be a polyethylenically unsaturated monomer, for instance methylene bis acrylamide, butane diol diacrylate and tetra allyl ammonium chloride.

Thickeners for use in the invention are for example alkali soluble aqueous emulsions of ethyl acrylate/methacrylic acid/steareth-10 mole ethoxylate allyl ether and having a weight average molecular weight below 1 million and preferably in the range 10,000 to 700,000 and more preferably in the range 50,000 to 200,000 or 250,000, and most preferably 70,000 and to below 100,000. Cross linkers and initiators can be included if desired.

Associative monomers are for instance ethylenically unsaturated monomers with hydrophobic groups and poly-ethoxylate spacers. For instance steareth-25 mol ethoxylate methacrylate, steareth-10 mol ethoxylate allyl ether or steareth-20 mol ethoxylate methacrylate.

The associative polymers are mildly associative; their associative monomer content being preferably not above 5% and more preferably below 2.5% by weight, based on the weight of the polymer.

The acid functionality may be provided by any suitable acid monomer, methacrylic acid, acrylic acid or a mixture thereof being preferred. The acid monomer content can be from 10 to 70%, preferably 20 to 50% by weight (based on the weight of polymer). As already indicated the precise values of the above parameters are chosen having regard to the viscosity and water retention that the particular coating operation demands and to the dosage of the thickener in the coating composition.

In use the thickener of the invention is included in a conventionally formulated coating composition for a pre-coat or top coat. The dosage of the thickener of the invention in the coating composition is kept as low as possible consistent with the required viscosity being obtained. For example, in many top coat formulations a dosage of thickener of 0.2 pph will give a target Brookfield viscosity of about 1000 to 1400 mPas at 100 rpm (typical for “roll and blade” coating method) in combination with good water retention of the order of 100 g/m² or lower. Unless otherwise stated the viscosity is measured at 25° C.

The target viscosity will to some extent be chosen having regard to the coating method that is to be used. Thus for film press a target Brookfield viscosity is of the order of 700 to 1000 mPas whereas for a jet applicator the target Brookfield viscosity is of the order of 2000 to 2500 mPas. In some instances the dosage may need to be altered in order to obtain the required viscosity. Of course, changing the dosage of thickener to obtain the desired viscosity can also change the water retention. However adjustment of the acid monomer content of the associative polymer can, in those circumstances, be used in order to secure good water retention.

When used the coating composition is preferably mildly alkaline, of the order of pH 8 to 10, preferably 8.5 to 9.5. Where necessary the pH can be adjusted for example by the addition of an alkali such as sodium hydroxide.

The invention also provides a method of modifying the rheology of a paper coating composition comprising adding to the coating composition a thickener as defined above.

Further the invention provides a paper coating method comprising coating paper or paperboard with a paper coating composition, said composition including a thickener as defined above.

The thickeners of the invention can be used in all methods of paper coating and at all possible coating weights for example from 2 to 25 g/m². The thickeners can be used in coating compositions for pre-coat, middle coat and top coat and can be used with any pigments and binders.

The following examples further illustrate the invention:

### EXAMPLE 1

### Preparation of Associative Thickener

Into a 700 ml resin pot fitted with stirrer, thermometer, nitrogen inlet and outlet, condenser and feed lines was placed 157.62 gms deionised water and 10.5 gms Disponil FES993 (Alkylether sulphate, sodium salt).

The contents of the resin pot were heated to 85° C. and then degassed with nitrogen for 30 minutes.

An aqueous emulsion was prepared by mixing 143.75 gms ethyl acrylate, 100.00 gms methacrylic acid, 6.25 gms steareth-10 ethoxylate allyl ether and 1.25 gms n-dodecyl mercaptan into 10.5 gms Disponil FES993 in 162.62 gms deionised water.

An initiator feed was prepared by dissolving 0.50 gms ammonium persulphate in 37.5 gms water.

After degassing, 0.25 gms ammonium persulphate dissolved in 5 gms water was added to the reactor followed by the start of the emulsion and initiator feeds over 2 and 3 hours respectively.

The contents of the reactor were held between 83 and 87° C. during the feed time and held for a further 1 hour at 85° C. to reduce residual monomer content.

The contents were then cooled to <40° C. and filtered.

This resulted in an aqueous emulsion polymer having a weight average molecular weight of about 150,000 with a solids content of 41.0%.

### EXAMPLE 2

A top coat was prepared according to the following recipe:

### Mix @ 1200 cps

60 parts CaCO₃ (Carbital 95)
40 parts Clay (Suprawhite 95)
10 parts SB latex (DL 950)
Solids content: 60%

Different thickeners were added to the mix and the pH adjusted by the addition of 1.0% sodium hydroxide solution. The dosages of thickener and the high shear viscosity and water retention obtained are set out in the following Table 1.

TABLE 1

| | | Parity | | Amount | | AA-GWR(gsm) | Cone & |
|---|---|---|---|---|---|---|---|
| | Dose | (against | | 1% NaOH | Brookfield | Water | Plate, |
| Sample | (pph) | control) | pH | (mls) | Viscosity | Retention | HSV |
| Blank | — | — | 8.57 | 4.50 | 148 | 232 | 28 |
| Control | 0.60 | 100 | 8.67 | 5.50 | 1190 | 155 | 47 |
| (CMC) | | | | | | | |
| A | 0.20 | 33 | 8.60 | 9.00 | 1150 | 215 | 43 |
| B | 0.315 | 53 | 8.54 | 11.0 | 1290 | 153 | 40 |
| C | 0.33 | 55 | 8.62 | 11.0 | 1140 | 153 | 48 |
| D | 0.34 | 57 | 8.52 | 11.0 | 1160 | 157 | 35 |
| E | 0.45 | 75 | 8.45 | 13.0 | 1270 | 146 | 41 |

The composition of the control and samples A to E were as follows (all percentages by weight):

Control: Commercially available carboxymethyl cellulose
A: Commercially available hydrophobic alkali swellable emulsion HASE
B: Ethyl acrylate 55% methacrylic acid 40%; steareth-10 ethoxylate allyl ether 5%
C: Ethyl acrylate 57.5% methacrylic acid 40%; steareth-10 ethoxylate allyl ether 2.5%
D: Ethyl acrylate 58% methacrylic acid 40%; steareth-25 ethoxylate methacrylate 2%
E: Ethyl acrylate 58% methacrylic acid 40%; steareth-10 ethoxylate allyl ether 2%

Compositions B to E also included about 5000 ppm of n-dodecyl mercaptan.

For the evaluation of the results the compositions of the invention were judged by comparison of their viscosity and water retention with the control sample where the thickener was carboxymethyl cellulose and HASE thickener A. The thickeners of the invention gave lower high shear viscosity than control and about the same water retention. The HASE thickener gave about the same high shear viscosity as the thickeners of the invention, but significantly worse water retention. Note that the dosage of HASE thickeners and the thickeners of the invention was about the same.

Water Retention GWR (gsm)

The water retention was measured in gsm on a gravimetric water retention meter using the parameters of 2 minutes dwell time, 1.5 bar pressure and 5 μm polycarbonate membrane filters.

### High Shear Viscosity (HSV)

The high shear viscosity was measured in mPas on a cone and plate viscometer at 10000s⁻¹.

### EXAMPLE 3

Certain of the samples used in Example 2 were added to a top coat composition. The dosages and the resultant viscosity and water retention are shown in the following Table 2.

| | | Brookfield | ACAV | Water | Haake |
|---|---|---|---|---|---|
| | Dosage | Viscosity | 0.6M 1/s | Retention | 3000 1/s |
| Sample | pph | (100 rpm) mPas | mPas | g/m² | mPas |
| Control | 0.6 | 1210 | 43 | 88 | 42 |
| A | 0.185 | 1280 | 38 | 123 | 31 |
| B | 0.2 | 1240 | 36 | 100 | 29 |
| C | 0.25 | 1400 | 37 | 93 | 31 |

The results confirm the results of Example 2, i.e. with the thickeners of the invention (B and C) it is possible to get low high shear and good water retention. On the other hand typical HASE thickener (A) also gives low high shear viscosity but poor water retention.

ACAV measured with a capillary viscometer in which pressure in a cylinder forces the sample through a capillary. By measuring pressure in the cylinder and knowing the flow rate of the sample through the capillary the shear rate and viscosity of the sample can be determined.

Water retention was measured on a gravimetric water retention meter using the parameters of 2.0 minutes dwell time, 0.5 bar pressure and 5 micrometer membrane filters using a 20 ml sample. (Water retention was measured in the same way in the following Examples 4 and 5).

### EXAMPLE 4

A pre-coat formulation was prepared as follows:

100 parts CaCO₃
10 parts SB-latex

| | |
|---|---|
| Solids content: | 63.0% |
| pH: | 9 |
| The target Brookfield viscosity (100 rpm): | 900 mPas |

Samples were added to the pre-coat formulation in the dosages set out in the following Table 3 which also shows the resultant viscosity and water retention.

TABLE 3

| | | Brookfield | ACAV | Water | Haake |
|---|---|---|---|---|---|
| | Dosage | Viscosity | 0.6M 1/s | Retention | 3000 1/s |
| Sample | pph | (100 rpm) mPas | mPas | g/m² | mPas |
| Control | 0.75 | 805 | 33 | 207 | 44 |
| A | 0.18 | 900 | 27 | 202 | 29 |
| B | 0.3 | 945 | 26 | 137 | 33 |
| C | 0.45 | 1060 | 27 | 120 | 38 |

The results show that the control sample and the HASE thickener A provide a poor water retention whereas the thickeners of the invention provide the required viscosity and good water retention.

### EXAMPLE 5

A pre-coat formulation was made up as follows:

100 parts CaCO₃
6 parts SB latex
6 parts starch

| | |
|---|---|
| Solids content: | 62% |
| pH: | 8.5 |
| Target Brookfield viscosity (100 rpm): | 800 mPas |

Samples of thickener compositions were added to the pre-coat formulation in the dosages shown in Table 4 which also sets out the resultant viscosity and water retention.

TABLE 4

| | | Brookfield | | |
|---|---|---|---|---|
| | | Viscosity | ACAV | Water |
| | Dosage | (100 rpm) | 0.6M 1/s | Retention |
| Sample | pph | mPas | mPas | g/m² |
| Control | 0.2 | 810 | 52 | 116 |
| A | 0.15 | 840 | 53 | 88 |
| B | 0.25 | 840 | 54 | 64 |
| C | 0.29 | 800 | 50 | 65 |

The results show better water retention for the control and HASE thickener A than in the pre-coat formulation of Example 4, which does not contain starch. However the thickeners of the invention have significantly further improved water retention.

### EXAMPLE 6

Various coating formulations were prepared employing thickener compositions selected from a commercial HASE thickener, a commercial ASE thickener and in a thickener composition according to the invention. The composition of the coating formulation is a shown in Table 5.

TABLE 5

| Materials | 1 | 2 | 3 | 4 | 8 | 9 | 10 | 14 | 15 | 16 |
|---|---|---|---|---|---|---|---|---|---|---|
| Premier | 75 | 75 | 75 | 75 | 75 | 75 | 75 | 75 | 75 | 75 |
| Hydrocarb 90 | 25 | 25 | 25 | 25 | 25 | 25 | 25 | 25 | 25 | 25 |
| Dispex N. 40 | 0.15 | 0.15 | 0.15 | 0.15 | 0.15 | 0.15 | 0.15 | 0.15 | 0.15 | 0.15 |
| TSPP | 0.05 | 0.05 | 0.05 | 0.05 | 0.05 | 0.05 | 0.05 | 0.05 | 0.05 | 0.05 |
| Dow 620 | 16 | 16 | 16 | 16 | 16 | 16 | 16 | 16 | 16 | 16 |
| AZC | 0.2 | 0.2 | 0.2 | 0.2 | 0.2 | 0.2 | 0.2 | 0.2 | 0.2 | 0.2 |
| Glosscole 50 | 0.4 | 0.4 | 0.4 | 0.4 | 0.4 | 0.4 | 0.4 | 0.4 | 0.4 | 0.4 |
| Commercial HASE | 0 | 0 | 0 | 0 | 0 | 0 | 0 | 0.1 | 0.2 | 0.26 |
| thickener | | | | | | | | | | |
| Commercial ASE | 0 | 0.1 | 0.2 | 0.4 | 0 | 0 | 0 | 0 | 0 | 0 |
| thickener | | | | | | | | | | |
| Sample F | 0 | 0 | 0 | 0 | 0.1 | 0.2 | 0.4 | 0 | 0 | 0 |
| pH | 8.5 | 8.5 | 8.5 | 8.5 | 8.5 | 8.5 | 8.5 | 8.5 | 8.5 | 8.5 |
| solids | 66 | 66 | 66 | 66 | 66 | 66 | 66 | 66 | 66 | 66 |

Sample F: Ethyl acrylate 57.5% methacrylic acid 40%; steareth-20 ethoxylate allyl ether 2.5%

The following tests were carried out on the formulations:

Measure Brookfield viscosity, 20 rpm, 100 rpm at 4 min.
Measure AAGWR at 2 bar pressure for 2 minutes
Measure Hercules High Shear viscosity, (FF bob, 6600 rpm, 138,534 1/sec).
Run twice with 3 minute delay between measurements.

The results are shown in Table 6

TABLE 6

| Results | 1 | 2 | 3 | 4 | 8 | 9 | 10 | 14 | 15 | 16 |
|---|---|---|---|---|---|---|---|---|---|---|
| % solids | 66.57 | 66.29 | 66.39 | 66.37 | 66.45 | 66.59 | 66.2 | 66.34 | 66.47 | 66.67 |
| pH | 8.59 | 8.79 | 8.45 | 8.85 | 8.78 | 8.75 | 8.3 | 8.35 | 8.37 | 8.32 |
| Brookfield viscosity 4/20 | 804 | 1812 | 5200 | 10700 | 1990 | 3222 | 7500 | 4080 | 12810 | 19020 |
| Brookfield viscosity 4/100 | 289 | 560 | 1512 | 2880 | 642 | 1022 | 2244 | 1626 | 3480 | 5208 |
| Hercules, cps | 64.3 | 61.3 | 72.5 | 91.1 | 60.7 | 74.8 | 72.2 | 72.8 | 69 | 77 |
| hysterisis | L | L | L | M | L | M | M | L | M | M-H |
| AAGWR (g/m2) | 276.4 | 187.6 | 143 | 110.7 | 195.7 | 164.1 | 115 | 234 | 173.3 | 152.4 |

The results show that sample F provides an excellent combination of low high shear viscosity and water retention values. In addition sample F exhibits significantly improved water retention than the conventional associative thickener (commercial HASE). This is also clear from FIG. 1.

### EXAMPLE 7

Thickener composition sample F was used in and in a coating formulation to coat paper in a pilot trial.

Details of the conditions used are as follows:

| | |
|---|---|
| Base paper: | 42 g/m2 |
| Speed: | 1820 m/min |
| Coat weight: | 7 g/m2/side |
| Coating unit: | Film press, one-sided |

| Recipes: | Reference | Sample F |
|---|---|---|
| Pigment mixture | 100 parts | 100 parts |
| SB-latex (DL 920) | 8 parts | 8.5 parts |
| Starch (Raisamyl 302E) | 6 parts | 3.5 parts |
| FWA (Blankophor P) | 0.6 parts | 0.6 parts |
| Sample F | — | 0.2 parts |

The results are shown in Table 7.

TABLE 7

| | Reference | Sample F |
|---|---|---|
| Coating color properties | | |
| Brookfield, at the beginning | 556 | 540 |
| Brookfield, in the middle | 572 | 574 |
| Brookfield, at the end | 574 | 564 |
| Solids, at the beginning | 59.3 | 59.2 |
| Solids, in the middle | 59.5 | 59.3 |
| Solids, at the end | 59.6 | 59.4 |
| Water retention | 111 | 95 |
| pH | 8.8 | 8.6 |
| Temperature | 36 | 33 |
| Rod pressure, bar | | |
| 1st side | | |
| at the beginning | 166 | 158 |
| at the end | 175 | 160 |
| 2nd side | | |
| at the beginning | 150 | 130 |
| at the end | 160 | 130 |

### Observations

1. improved runnability
2. lower high shear viscosity (lower rod pressure)
3. better dynamic water retention (no increase of rod pressure)
4. less misting with sample F
5. It would have been possible to increase solids content of coating color

Associative thickener composition Sample F provides low high shear viscosity which gives lower rod pressure and better water retention gives more stable rod pressure.

### EXAMPLE 8

Thickener composition sample F and various other thickener compositions were used in coating formulations to coat paper in a pre coating pilot trial.

| Base paper: | Uncoated, 52 g/m2 (base paper for 90 g/m2 grade) |
|---|---|
| Pre-coating: | |
| Recipe: | 100 parts NPS CaCO3 (Covercarb 60-LV) |
| | 8 parts SB-latex (DL 920) |
| | 4 parts Starch (302 ESP) |
| | 0.6 parts FWA (Tinopal ABP-Z) |
| Pre-coating | |
| conditions: | |
| pH: | ca. 8.5 |
| Solids: | 62% |
| Brookfield: | 800-900 mPas |
| Temperature: | 29-31 C |
| Method: | Sym-sizer (double side) |
| Speed: | 1500 m/min |
| Coat weight: | 9 g/m2/side |
| Rod diameter: | 20 mm |
| Moisture: | 3.5% |

The results are shown in Table 8

TABLE 8

| | | | | Brookfield | | High shear | Rod |
|---|---|---|---|---|---|---|---|
| | | | | (100 rpm) | Water | viscosity | pressure |
| | Amount, | Solids, % | | mPas | retention | 1 M 1/s | bar |
| Thickener | parts | Start/End | pH | Start/End | g/m2 | mPas | Start/End |
| CMC | 0.2 | 61.9/62.0 | 8.4 | 480/470 | 162 | 39 | 1.3/1.3 |
| Commercial | 0.1 | 61.9/62.0 | 8.5 | 370/395 | 123 | 41 | 1.45/1.5 |
| ASE | | | | | | | |
| Commercial | 0.2 | 61.9/62.1 | 8.6 | 545/560 | 103 | 48 | 2.4/2.5 |
| ASE | | | | | | | |
| Sample F | 0.2 | 62.1/62.2 | 8.4 | 430/470 | 108 | 39 | 1.3/1.3 |

The results show that the thickener according to the present invention exhibits the best combination of low high shear viscosity and water retention over CMC or commercial ASE thickener. It can be seen that the CMC gave low high shear viscosity but poor water retention. The dose of commercial ASE thickener that provides low high shear viscosity gives poor water retention whereas a dose and of the same thickener and that provides good water retention exhibits poor high shear viscosity. Furthermore, the coating composition made using the thickener of the present invention provided better runability and no or low misting.

### EXAMPLE 9

Thickener composition sample F and various other thickener compositions were used in coating formulations to coat paper in a top coating pilot trial.

| Base paper: | Pre-coated, 52 g/m2 (pre-coated paper for 65 g/m2 grade) |
|---|---|
| Recipe: | 70 parts fine CaCO3 (Covercarb 85) |
| | 30 parts fine Clay (Hydragloss 90) |
| | 11 parts SB-latex (XZ 96445) |
| | 0.6 parts PVA (Airvol 103) |
| | 0.6 parts Ca-stearate (Raisacote CAS 50) |
| | 0.2 parts hardener (Bacote 20) |
| | 0.6 parts FWA (Tinopal ABP-Z) |
| Coating | |
| conditions: | |
| pH: | ca. 8.5 |
| Solids: | 63% |
| Brookfield: | 1200-1500 mPas |
| Temperature: | 27-28 C |
| Method: | Opticoat-jet |
| Speed: | 1500 m/min |
| Coat weight: | 9 g/m2/side |
| Blade width: | 0.457 mm |
| Moisture: | 5.0% |

The results are shown in Table 9.

TABLE 9

| | | | | Brookfield | | High shear | Blade |
|---|---|---|---|---|---|---|---|
| | | | | (100 rpm) | Water | viscosity | pressure |
| | Amount, | Solids, % | | mPas | retention | 1 M 1/s | bar |
| Thickener | parts | Start/End | pH | Start/End | g/m2 | mPas | Start/End |
| CMC | 0.6 | 63.0/62.8 | 8.2 | 1180/1220 | 122 | 44 | *0.99/0.99 |
| | | | | | | | **1.07/1.03 |
| commercial | 0.2 | 63.0/62.8 | 8.2 | 680/650 | 118 | 44 | *0.93/0.95 |
| ASE | | | | | | | **0.99/0.97 |
| commercial | 0.3 | 63.2/63.0 | 8.2 | 985/940 | 111 | 47 | *1.01/1.03 |
| ASE | | | | | | | **1.10/1.08 |
| Sample F | 0.3 | 63.0/62.6 | 8.3 | 750/690 | 110 | 39 | *0.95/0.94 |
| | | | | | | | **0.96/0.95 |

*= first side
**= second side

This shows that the associative thickener of the present invention provided the best combination of low high shear viscosity and good water retention.

1. A process for coating paper, which process comprises applying a paper coating composition to at least one surface of a sheet of paper and drying the coated sheet,
wherein the paper coating composition exhibits an improved combination of low high shear viscosity and high water retention properties,
where the paper coating composition comprises an associative thickener which comprises
an associative polymer containing less than 10% by weight, based on the weight of the polymer, of associative monomer units, at least 10% by weight, based on the weight of the polymer, of acid monomer units, and where the polymer has a weight average molecular weight of less than 1 million.

2. A process according to claim 1, where the associative thickener is a hydrophobic alkali-soluble emulsion.

3. A process according to claim 1, where the associative polymer has a molecular weight of from 10,000 to 700,000.

4. A process according to claim 1, wherein the acid monomer is selected from methacrylic acid, acrylic acid and mixtures thereof.

5. A process according to claim 1, where the associative polymer is branched or crosslinked.

6. A process according to claim 1, where the associative polymer contains less than 5.0% by weight of associative monomer units.

7. A process according to claim 1, where the pH of the coating composition is from 8 to 10.

8. A process according to claim 1 for roll and blade coating, where the coating composition has a Brookfield viscosity (100 rpm) of the order of 1000 to 1400 mPas.

9. A process according to claim 1 for coating by film press, where the coating composition has a Brookfield viscosity (100 rpm) of the order of 700 to 1000 mPas.

10. A paper according to claim 1 for coating by jet applicator, where the coating composition Brookfield viscosity (100 rpm) of the order of 2000 to 2500 mPas.

11. A process according to claim 1, wherein the associative thickener is the sole thickener ingredient.

12. A paper coating composition that exhibits an improved combination of low high shear viscosity and high water retention properties,
where the paper coating composition comprises an associative thickener which comprises
an associative polymer containing less than 10% by weight, based on the weight of the polymer, of associative monomer units, at least 10% by weight, based on the weight of the polymer, of acid monomer units, and where the polymer has a weight average molecular weight of less than 1 million.
